(19) United States
(12) Patent Application Publication
(10) Pub. No.: US 2021/0215493 A1
(43) Pub. Date: Jul. 15, 2021

(54) VEHICLE LOADING FEEDBACK FOR BEV PERFORMANCE

(71) Applicant: Ford Global Technologies, LLC, Dearborn, MI (US)

(72) Inventors: Jimmy KAPADIA, Ottawa Hills, OH (US); Nayaz Khalid AHMED, Canton, MI (US); Connor COOPER, Northville, MI (US)

(73) Assignee: Ford Global Technologies, LLC, Dearborn, MI (US)

(21) Appl. No.: 16/743,479

(22) Filed: Jan. 15, 2020

(51) Int. Cl. G01C 21/34; G01G 19/08; B60L 58/13; B60W 20/12

(52) U.S. Cl. CPC G01C 21/3453; G01G 19/08; B60L 58/13; B60W 2556/45; B60L 2240/46; B60W 2552/15; B60W 20/12

(57) ABSTRACT

A vehicle powered by a traction battery includes one or more controllers, programmed to measure a vehicle load, responsive to identifying a road climb having a grade greater than a predefined threshold on a route, calculate a required power and a minimum speed for the vehicle to complete the road climb with the vehicle load, predict an operating state of charge (SoC) and an operating temperature of the traction battery upon arriving at the road climb, predict an available battery power using the operating SoC and the operating temperature of the traction battery, estimate an available wheel power using the available battery power, and responsive to verifying the available wheel power is greater than the required power, output an autonomous driving instruction such that the vehicle enters and traverses the road climb with the minimum speed.

### TECHNICAL FIELD

The present disclosure generally relates to a system for an electric vehicle.

### BACKGROUND

With the proliferation of battery electric vehicles (BEVs), vehicle manufacturers may choose to use a common powertrain across multiple vehicles, including a wide range of cargo vehicles (e.g. cargo vans, and trucks). As a result, heavier vehicles may be underpowered and may be unable to perform some driving maneuvers when heavily loaded. For instance, a vehicle may be capable of going up a 10% grade when loaded to 80% capacity but may be unable to do so at full loading capacity.

### SUMMARY

A vehicle powered by a traction battery includes one or more controllers, programmed to measure a vehicle load, responsive to identifying a road climb having a grade greater than a predefined threshold on a route, calculate a required power and a minimum speed for the vehicle to complete the road climb with the vehicle load, predict an operating state of charge (SoC) and an operating temperature of the traction battery upon arriving at the road climb, predict an available battery power using the operating SoC and the operating temperature of the traction battery, estimate an available wheel power using the available battery power, and responsive to verifying the available wheel power is greater than the required power, output an autonomous driving instruction such that the vehicle enters and traverses the road climb with the minimum speed.

A method for a vehicle powered by a traction battery includes measuring a vehicle load via a load sensor, calculating a delivery route using a delivery mission wirelessly received, responsive to identifying a predefined road condition on the delivery route, calculating a required power to complete the road condition with the vehicle load, obtaining a weather condition around the road condition from a cloud server, predicting an operating SoC and an operating temperature for the traction battery upon arriving at the road condition, predicting an available battery power using the operating SoC and the operating temperature of the traction battery, estimating an available wheel power using the available battery power, and responsive to verifying the available wheel power is sufficient to complete the road condition by comparing the available wheel power with the required power, outputting a driving instruction.

A non-transitory computer-readable medium includes instructions, when executed by a controller of a vehicle, make the vehicle responsive to receiving a delivery mission, plan a delivery route, identify a predefined road condition on the delivery route, responsive to detecting a traction battery is being charged by a charger while the vehicle is in a loading mode, predict an operating SoC using a current SoC and a charging power of the charger, calculate a loading time to load the vehicle, and calculate an optimal load to complete the road condition using the operating SoC and the loading time.

### BRIEF DESCRIPTION OF THE DRAWINGS

FIG. 1 is a diagram of an electrified vehicle illustrating drivetrain and energy storage components including an electric machine.

FIG. 2 is a diagram of a vehicle system and a maneuver example.

FIG. 3 is a flow diagram of the vehicle feedback method.

FIG. 4 is a flow diagram of another vehicle feedback method.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

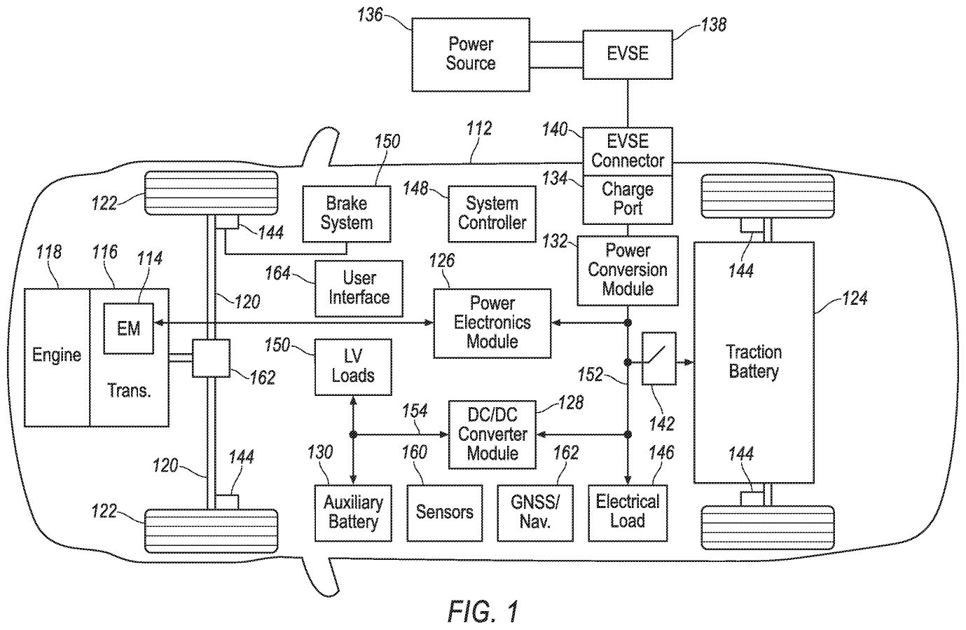

FIG. 1 depicts an electrified vehicle 112 that may be referred to as a plug-in hybrid-electric vehicle (PHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and braking capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. An electrified vehicle 112 may also be a BEV. In a BEV configuration, the engine 118 may not be present.

A traction battery or battery pack 124 stores energy that can be used by the electric machines 114. The vehicle battery pack 124 may provide a high voltage direct current (DC) output. The traction battery 124 may be electrically coupled to one or more power electronics modules 126 (may also be referred to as a traction inverter). One or more contactors 142 may isolate the traction battery 124 from other components when opened and connect the traction battery 124 to other components when closed. The power electronics module 126 is also electrically coupled to the electric machines 114 and provides the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

The vehicle 112 may include a variable-voltage converter (VVC) (not shown) electrically coupled between the traction battery 124 and the power electronics module 126. The VVC may be a DC/DC boost converter configured to increase or boost the voltage provided by the traction battery 124. By increasing the voltage, current requirements may be decreased leading to a reduction in wiring size for the power electronics module 126 and the electric machines 114. Further, the electric machines 114 may be operated with better efficiency and lower losses.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads. An output of the DC/DC converter module 128 may be electrically coupled to an auxiliary battery 130 (e.g., 12V battery) for charging the auxiliary battery 130. The low-voltage systems may be electrically coupled to the auxiliary battery 130. One or more electrical loads 146 may be coupled to the high-voltage bus/rail. The electrical loads 146 may have an associated controller that operates and controls the electrical loads 146 when appropriate. Examples of electrical loads 146 may be a fan, an electric heating element and/or an air-conditioning compressor.

The electrified vehicle 112 may be configured to recharge the traction battery 124 from an external power source 136. The external power source 136 may be a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

One or more wheel brakes 144 may be provided for braking the vehicle 112 and preventing motion of the vehicle 112. The wheel brakes 144 may be hydraulically actuated, electrically actuated, or some combination thereof. The wheel brakes 144 may be a part of a brake system 150. The brake system 150 may include other components to operate the wheel brakes 144. For simplicity, the figure depicts a single connection between the brake system 150 and one of the wheel brakes 144. A connection between the brake system 150 and the other wheel brakes 144 is implied. The brake system 150 may include a controller to monitor and coordinate the brake system 150. The brake system 150 may monitor the brake components and control the wheel brakes 144 for slowing the vehicle. The brake system 150 may respond to driver commands and may also operate autonomously to implement features such as stability control. The controller of the brake system 150 may implement a method of applying a requested brake force when requested by another controller or sub-function.

Electronic modules in the vehicle 112 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by Institute of Electrical and Electronics Engineers (IEEE) 802 family of standards. Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 1 but it may be implied that the vehicle network may connect to any electronic module that is present in the vehicle 112.

A vehicle system controller (VSC) 148 may be present to control and coordinate the operation of the various components. The VSC 148 may be provided with processing and storage capabilities configured to monitor data from various sensors 160 and control various operations of the vehicle 112. The sensors 160 may include various types of sensing devices located throughout the vehicle 112 to measure a wide-range of data of the vehicle. As a few non-limiting examples, the sensors 160 may include a battery temperature sensor mounted to the traction battery 124 configured to measure a temperature of battery cells. The sensors 160 may further include a vehicle load sensor configured to measure a vehicle load (particularly for a cargo vehicle). The load sensor 160 may be mounted on one or more suspension components of the vehicle 112 for weight measurement. Additionally, in case that the vehicle 112 is connected to a trailer, the load sensor 160 may be mounted on the trailer. The vehicle 112 may be further provided with location and navigation features via a global navigation satellite system (GNSS) and navigation controller 162. The GNSS and navigation controller 162 may be configured to communicate with multiple satellites and calculate the location and navigation route of the vehicle 112. The GNSS and navigation controller 162 may be configured to support various current and/or future global or regional location systems such as global positioning system (GPS), Galileo, Beidou, Global Navigation Satellite System (GLONASS) and the like. The vehicle 112 may be further provided with a user interface 164 (a.k.a. human-machine interface (HMI)) configured to provide user interaction with the vehicle 112. For instance, the user interface 164 may be associated with one or more displays and/or speakers (not shown) configure to output video and/or audio message to the user.

The VSC 148 may be configured to function as a central coordinator for multiple vehicle components to perform various operations. For instance, the VSC 148 may be configured to calculate an available power output of the electric machine 114 based on various factors such as a state of charge (SoC) of the traction battery 124, battery temperature or the like. Such calculation may be particularly relevant if the vehicle 112 is a BEV without the engine 118 as it may be preferable or sometimes necessary to determine available maneuvers (e.g. hill climbing) based on the available power output. Additionally, the VSC 148 may be further configured to calculate a power required for performing a specific maneuver such as climbing a hill based on data including vehicle load, road grade or the like. With both the available power and required power for a specific maneuver calculated, the VSC 148 may output instructions to the vehicle driver via the user interface 164.

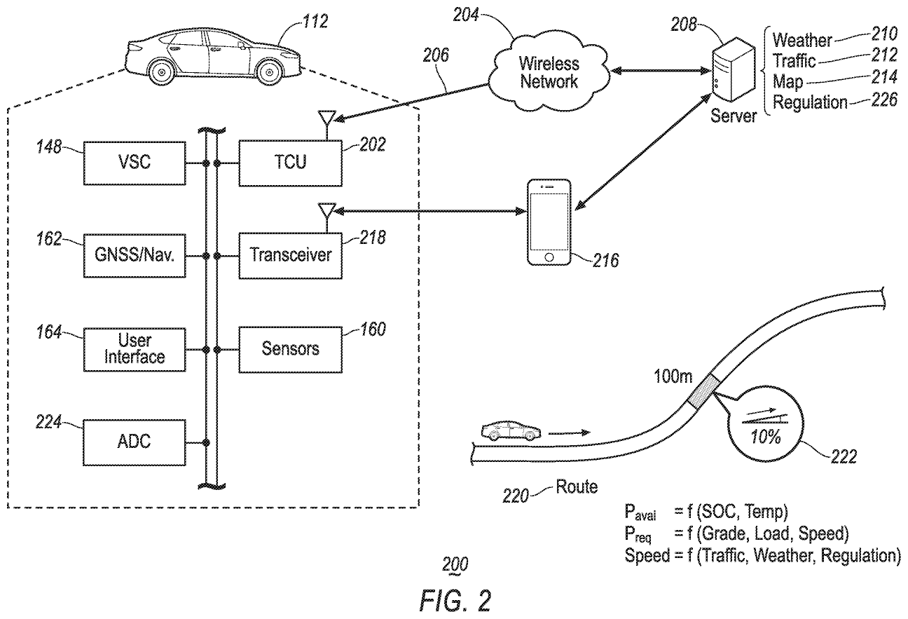

Referring to FIG. 2, a diagram of a vehicle system and a maneuver example is illustrated. With continuing reference to FIG. 1, the vehicle 112 may be further provided with a telematics control unit (TCU) 202 configured to control telecommunication between the vehicle 112 a wireless network 204 through a wireless connection 206 using hardware such as a modem (not shown). The wireless network 204 may be in the form of a variety of communication networks, e.g. a cellular network. Through the wireless network 204, the vehicle 112 may access one or more servers 208 to access various content for various purposes. For instance, the vehicle 112 may access weather data 210, traffic data 212, and map data 214 via the server 208. The vehicle 112 may further access regulations (e.g. speed limit) of a specific route via the server 208. It is noted that terms wireless network and server are used as general terms in the present disclosure and may include any computing network involving carrier, router, computers, controllers, switches or the like configured to store data and perform data processing and transmissions to facilitate communication between various entities. The vehicle 112 may be further provided with a wireless transceiver 218 in support of various wireless communication protocol configured to communicate with a mobile device 216. For instance, the wireless transceiver 218 may be configured to support communication protocols including Wi-Fi, Bluetooth, radio-frequency identification (RFID), near-field communication (NFC), ultra-wide band (UWB) or the like. The mobile device 216 may be any of various types of portable computing devices, such as cellular phones, tablet computers, wearable device, smart watches, smart fobs, laptop computers, portable music player, or other device capable of communication with the vehicle 112. For instance, the mobile device 216 may be a cell phone associated with a vehicle user (e.g. driver) and provided with cellular connection capabilities to access content of the server 208. The vehicle 112 may be further provided with autonomous driving features via an autonomous driving controller (ADC) 224 configured to operate the vehicle 112 in an autonomous manner. Data required for the autonomous driving may be provided by the sensors 160 and/or the server 208 through the TCU 202.

The VSC 148 of the vehicle 112 may be configured to identify and analyze a road condition 222 for a route 220 calculated by the GNSS and navigation controller 162. For instance, the road condition may be a 10% grade road climbing for one hundred meters as illustrated in FIG. 2. The VSC 148 may be configured to predict an available power Pₐᵥₐᵢ of the electric machine upon encountering the road condition as a function of an operating SoC and temperature of the traction battery 124.

Pₐᵥₐᵢ=f(SoC,Temp)

As the battery discharges, the available power Pₐᵥₐᵢ generally drops. The exact relationship between power and SOC is dependent on the battery chemistry. As for the temperature factor, batteries have peak power generally around 72° F., with an approximate range between 66° F. and 78° F. Deviating from that range, the available battery power Pₐᵥₐᵢ generally falls due to chemistry and/or battery life considerations.

The VSC 148 may be further configured to calculate a required power P_{req} for the vehicle to overcome the road condition based on various factors including the road grade, vehicle load and available speed for the vehicle while entering and traversing the road condition.

P_{req}=f(grade,load,speed)

The above equation may be further developed more specifically into:

P_{req}=speed*(weight*acceleration+weight*g*sin(grade_{angle})f(speed))

wherein g represents the acceleration due to gravity (approximately 9.8 m/s²) and f(speed) represents other losses of the vehicle due to various factors (e.g. friction, aero or etc.) which are generally a function of vehicle speed. The available speed of the vehicle may be further dependent on factors such as traffic 212, weather 210 and regulations/speed limit where the road condition occurs.

Speed=f(traffic,weather,regulation)

Having both the available power Pₐᵥₐᵢ and the required power P_{req} calculated, the VSC 148 may compare the two powers to determine if the vehicle 112 is able to successfully overcome/complete the road condition 222. The VSC 148 may output driving instructions to the user via the user interface 164 based on the determination. It is noted that there is a difference between the available battery power Pₐᵥₐᵢₗ calculated above and the available power at the wheels P_{wheel} due to losses in the powertrain between the battery and the wheels. The power loss may be generally estimated to be 15% to 20% of the available battery power Pₐᵥₐᵢₗ. Therefore, the available power on the wheels may be estimated using the following equation.

P_{wheel}≈0.8*Pₐᵥₐᵢₗ

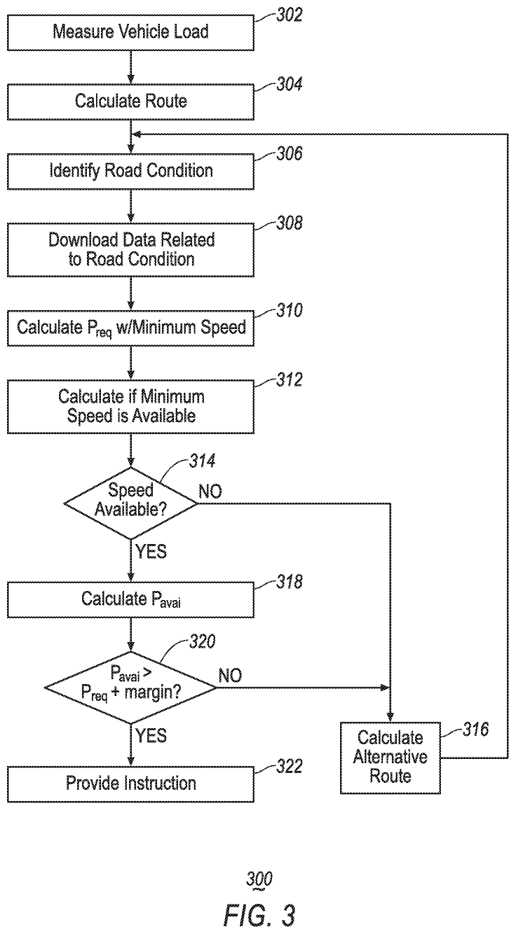

The available power on the wheels P_{wheel} may be used instead of the available battery power Pₐᵥₐᵢₗ to compare with the required power P_{req} which represents the required power at the wheel, to provide a more accurate estimation. Referring to FIG. 3, a flow diagram for a vehicle load feedback process 300 is illustrated. With continuing reference to FIGS. 1 and 2, at operation 302, the VSC 148 measures the load of the vehicle 112 using data received from the load sensor 160. The vehicle load may be a specific weight (e.g. 3,000 kilogram) or a percentage of predefined full load capacity (e.g. 80% load) allowing the VSC 148 to perform calculations. At operation 304, the VSC 148 calculates the vehicle route 220 for a delivery via the GNSS and navigation controller 162. The vehicle route 220 may be calculated based on a navigation destination set by a vehicle user. Alternatively, the destination may be received from the server 208 or the mobile device 216 of the vehicle driver. Alternatively, in case that no specific destination is set to the GNSS and navigation controller 162, the vehicle route 220 may be predicted based on a current route being traversed by the vehicle as well as one or more vehicle historical travel paths and/or destinations. Responsive to identifying the route 220, at operation 306, the VSC 148 identifies a road condition 222 on the route 220. The road condition 222 may include one or more predefined conditions identifiable by the VSC 148. For instance, the road condition 222 may include a road grade greater than a predefined threshold (e.g. >8%) defined by the map data 214, a traffic event (e.g. road work, or accident) defined by the traffic data 212, and/or a weather event (e.g. ice, flood or fire) defined by the weather data 210. Continuing to use the example illustrated with reference to FIG. 2, the VSC 148 may identify any uphill on the route 220 greater than a predefined threshold. In the present example the 10% grade road may be identified. In an alternative example, the VSC 148 may be configured to adjust the threshold of the road condition 222 as a function of the vehicle load measure at operation 302. For instance, the heavier the vehicle load is, the lower the road grade threshold may become.

Grade_{threshold}=f(load)

Responsive to identifying the road condition 222, at operation 308, the VSC 148 obtains and downloads data related to the road condition 222 from the server 208. Depending on the specific road condition, the data related may vary. For instance, the data related to the road condition 222 may include weather data 210 affecting vehicle battery temperature near the location of the road condition 222, traffic data 212 and regulation data 226 (e.g. speed limit) affecting the available speed for the vehicle 112. The vehicle 112 may download the data via the TCU 202. Additionally or alternatively, in case that the mobile device 216 is connected, the vehicle 112 may access the server 208 and download the data via the mobile device 216.

At operation 310, the VSC 148 calculates the power required P_{req} to overcome the road condition 222 with a minimum speed required. As discussed above with reference to FIG. 2, in case the road condition is a road grade, the required power P_{req} may be calculated as a function of the road grade, vehicle load, as well as the minimum speed. For instance, the vehicle 112 may be able to complete the climb if it enters the hill with 80% load at a minimum speed of 20 mph during the climb, but will be unable to complete the maneuver if the speed is below 20 mph (e.g. vehicle stalls). However, the required minimum speed as calculated sometimes may not be available for the specific road condition 222 due to various reasons such as speed limit. Therefore, at operation 312, the VSC 148 verifies the availability of the minimum speed based on information downloaded from the server 208 such as the traffic 210, weather 212, regulation 226 or the like as discussed above. If the VSC verifies the minimum speed is not available at operation 314, the process proceeds to operation 316 and the VSC 148 calculates an alternative route via the GNSS and navigation controller 162. The process returns to operation 306 to identify any road conditions on the alternative route. If the answer for operation 314 is yes, the process proceeds to operation 318 and the VSC 148 calculates the power available Pₐᵥₐᵢ to the vehicle 112 at the road condition 222 based on factors including a predicted operating SoC, a predicted battery temperature or the like during the traversing of the road condition. As discussed above, the power available to the vehicle wheels may be estimated from the available battery power taking the powertrain losses into account. For the sake of description simplicity, the battery power and the wheel power will be collectively referred to as the available power Pₐᵥₐᵢₗ in the present example. The operating SoC may be predicted based on a current SoC of the traction battery 124 and a distance to the road condition. The operating temperature may be predicted based on factors such as ambient temperature from the weather data 210, and a predicted discharge power condition for the vehicle 112 to traverse the route 220 to the road condition 222. At operation 320, the VSC 148 compares the available power Pₐᵥₐᵢ with the required power P_{req} to determine if the vehicle 112 has enough power to overcome the road condition 222. A power margin may be added to the evaluation to provide some margin for performing the maneuver. The power margin may be added to account for battery power variation from vehicle to vehicle, degradation of battery capacity, inaccuracy of grade measurement from GNSS, load measurement inaccuracy or the like. The power margin may be a fixed value such as 10 kW predefined by the output power of the traction battery 124. Alternatively, the power margin me be dynamically calculated based on factors such as vehicle load, temperature, road grade, or the like.

P_{margin}=f(load,temperature,grade)

If the answer for operation 320 is no, the process proceeds to operation 316. Otherwise, the process proceeds to operation 322 and the VSC 148 outputs driving instructions to the vehicle driver. For instance, the driving instruction may be output via the user interface 164 informing the driving of the road condition 222 ahead. Additionally, the driving instructions may include the minimum speed calculated at operation 310 to overcome the road condition 222. In case the vehicle 112 is provided with autonomous driving features, the VSC 148 may be configured to output the driving instructions to the ADC 224 to perform the autonomous driving of the vehicle 112.

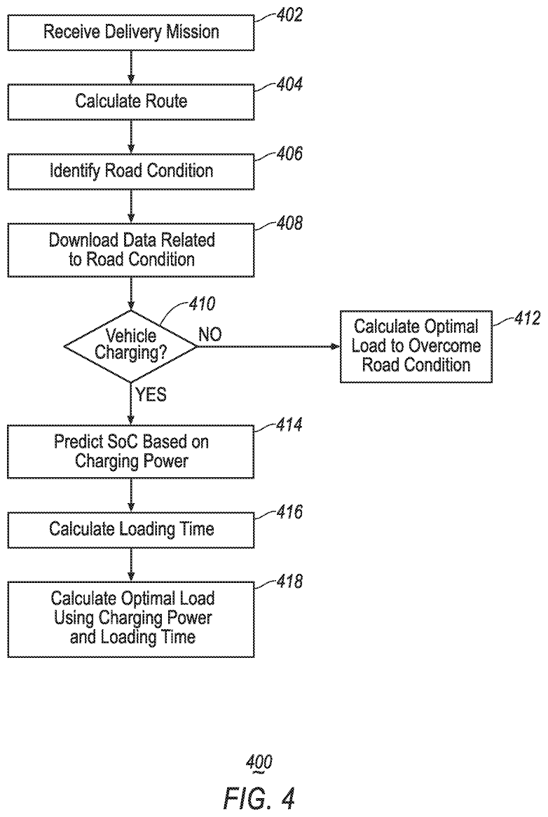

Referring to FIG. 4, a flow diagram of another vehicle feedback process 400 is illustrated. The process 400 may be applied to a situation in which the vehicle 112 receives a delivery mission before or while being loaded. With continuing reference to FIGS. 1-3, at operation 402, the VSC 148 receives the cargo delivery mission from the server 208. The delivery mission may include a destination and delivery time of the cargo delivery. Using the information of the delivery mission, at operation 404, the VSC 148 may calculate the delivery route 220. Operations 404 to 408 of the present embodiment are similar to operations 304 to 308 illustrated with reference to FIG. 3 and therefore, the description of which will not be repeated there.

At operation 410, the VSC verifies if the vehicle 112 is being charged by an EVSE 138. Since the loading duration may vary for a cargo vehicle and sometimes a loading process may take hours or days, a loading station may be provided with EVSEs 138 to charge the vehicle 112 while being loaded with cargos. If the answer for operation 410 is no, the process proceeds to operation 412 and the VSC 148 determines an optimal vehicle load recommended to overcome the road condition 222 without considering vehicle charging time (since the vehicle is not being charged). The optimal load may be calculated a function of factors such as predicted SoC, and battery temperature at the road condition, road grade of the like.

Lₒₚₜᵢₘₐₗ=f(SoC,temperature,grade)

At operation 410, if the VSC 148 detects the vehicle 112 is being charged by an EVSE 138, the process proceeds to operation 414 and the VSC 148 predicts the SoC at the road condition using the charging power of the EVSE 138. Depending on the specific configuration, the charging power of the EVSE 138 may vary significantly and thus affect the predicted the operating SoC when the vehicle arrives at the road condition 222.

SoC_{operating}=f(P_{charging})

At operation 416, the VSC 148 calculates the required time to load the vehicle. The loading time may be calculated by the total weigh and type of product of the cargo. At operation 418, the VSC 148 calculates the optimal load taking into account the charging power and loading time.

Lₒₚₜᵢₘₐₗ=f(SoC_{operating},T_{load},temperature,grade)

With the optimal load calculated, the VSC 148 may output a recommendation to the loading station to adjust the load accordingly. The process 400 illustrated with reference to FIG. 4 may be applied or combined with the process 300 illustrated with reference to FIG. 3 to provide a more comprehensive power estimation solution to the electric vehicle 112.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle powered by a traction battery, comprising:
one or more controllers, programmed to
measure a vehicle load,
responsive to identifying a road climb having a grade greater than a predefined threshold on a route, calculate a required power and a minimum speed for the vehicle to complete the road climb with the vehicle load,
predict an operating state of charge (SoC) and an operating temperature of the traction battery upon arriving at the road climb,
predict an available battery power using the operating SoC and the operating temperature of the traction battery,
estimate an available wheel power using the available battery power, and
responsive to verifying the available wheel power is greater than the required power, output an autonomous driving instruction such that the vehicle enters and traverses the road climb with the minimum speed.

2. The vehicle of claim 1, wherein the one or more controllers are further programmed to select a value for the predefined threshold based on the vehicle load such that as the vehicle load increases the value for the predefined threshold decreases.

3. The vehicle of claim 2, wherein the one or more controllers are further programmed to verify an availability of the minimum speed around the road climb using weather, traffic, and regulation data received from a cloud server.

4. The vehicle of claim 1, wherein the one or more controllers are further programmed to, responsive to verifying the available wheel power is insufficient to complete the road climb, calculate an alternative route.

5. The vehicle of claim 1, wherein the one or more controllers are further programmed to
measure a current SoC and current temperature of the traction battery, wherein the operating SoC of the traction battery is predicted using the current SoC and a driving distance from the road climb, and the operating temperature of the traction battery is predicted using the current temperature and a weather condition around the road climb received from a cloud server.

6. The vehicle of claim 1, wherein the one or more controllers are further programmed to, responsive to detecting the traction battery is being charged by a charger while the vehicle is in a loading mode, predict the operating SoC further using a charging power of the charger.

7. The vehicle of claim 6, wherein the one or more controllers are further programmed to calculate a loading time to load the vehicle, and calculate an optimal load to complete the road climb using the operating SoC, and the loading time.

8. The vehicle of claim 1, wherein the one or more controllers are further programmed to responsive to detecting the traction battery is not being charged while the vehicle is in a loading mode, calculate an optimal load using the operating SoC, the operating temperature of the traction battery, and the grade of the road.

9. The vehicle of claim 1, wherein the available wheel power is 85% to 90% of the available battery power.

10. A method for a vehicle powered by a traction battery, comprising:
measuring a vehicle load via a load sensor;
calculating a delivery route using a delivery mission wirelessly received;
responsive to identifying a predefined road condition on the delivery route, calculating a required power to complete the road condition with the vehicle load;
obtaining a weather condition around the road condition from a cloud server;
predicting an operating SoC and an operating temperature for the traction battery upon arriving at the road condition;
predicting an available battery power using the operating SoC and the operating temperature of the traction battery;
estimating an available wheel power using the available battery power; and
responsive to verifying the available wheel power is sufficient to complete the road condition by comparing the available wheel power with the required power, outputting a driving instruction.

11. The method of claim 10 further comprising selecting a value for the predefined threshold based on the vehicle load such that as the vehicle load increases the value for the predefined threshold decreases.

12. The method of claim 10 further comprising calculating a minimum speed for the vehicle to complete the road condition.

13. The method of claim 10 further comprising verifying an availability of the minimum speed at the road condition using weather, traffic, and regulation data received from the cloud server; and

14. The method of claim 13, further comprising, responsive to verifying the minimum speed is available, outputting the minimum speed via the driving instruction.

15. The method of claim 14 further comprising performing an autonomous driving using the driving instruction.

16. The method of claim 10, wherein the available wheel power is 85% to 90% of the available battery power.

17. A non-transitory computer-readable medium, comprising instructions, when executed by a controller of a vehicle, make the vehicle:
responsive to receiving a delivery mission, plan a delivery route;
identify a predefined road condition on the delivery route;
responsive to detecting a traction battery is being charged by a charger while the vehicle is in a loading mode, predict an operating SoC using a current SoC and a charging power of the charger;
calculate a loading time to load the vehicle; and
calculate an optimal load to complete the road condition using the operating SoC, and the loading time.

18. The non-transitory computer-readable medium of claim 17, further comprising instructions, when executed by the controller of the vehicle, make the vehicle select a value for the predefined threshold based on the vehicle load such that as the vehicle load increases the value for the predefined threshold decreases.

19. The non-transitory computer-readable medium of claim 17, further comprising instructions, when executed by the controller of the vehicle, make the vehicle:
obtain a weather condition around the road condition from a cloud server; and
calculate an operating temperature of the traction battery using the weather condition.

20. The non-transitory computer-readable medium of claim 19, further comprising instructions, when executed by the controller of the vehicle, make the vehicle:
calculate a minimum speed to complete the road condition using the operating temperature of the traction battery; and
output a driving instruction indicative of the minimum speed.
